(19) United States
(12) Patent Application Publication
(10) Pub. No.: US 2024/0324010 A1
(43) Pub. Date: Sep. 26, 2024

(54) PERIODIC PLMN SEARCH ATTEMPTS WHEN UNAVAILABILITY PERIOD IS ACTIVATED

(71) Applicant: Media Tak Singapore Pte.Ltd, Singapore (SG)

(72) Inventor: Puneet ., BengaluruKA (IN)

(21) Appl. No.: 18/582,775

(22) Filed: Feb. 21, 2024

(51) Int. Cl. H04W 74/0816; H04W 60/04; H04W 74/08; H04W 84/04

(52) U.S. Cl. CPC H04W 74/0816; H04W 60/04; H04W 74/0866; H04W 84/042

(57) ABSTRACT

In an aspect of the disclosure, a method, a computer-readable medium, and an apparatus are provided. The method may be performed by a UE. In certain configurations, the UE activates, by a processor of the UE, an unavailability period. The UE postpones, by the processor, a periodic Public Land Mobile Network (PLMN) search when the unavailability period is activated. The periodic PLMN search is controlled by a periodic attempt timer.

### CROSS-REFERENCE TO RELATED APPLICATION(S)

This application claims the benefits of Indian Provisional Application Serial No. 202321021005, entitled “IMPROVEMENTS IN PERIODIC PLMN SEARCH ATTEMPTS WHEN UNAVAILABILITY PERIOD IS ACTIVATED” and filed on Mar. 24, 2023, which is expressly incorporated by reference herein in their entirety.

### BACKGROUND

### Field

The present disclosure relates generally to communication systems, and more particularly, to techniques of methods and apparatuses for improvements in periodic Public Land Mobile Network (PLMN) search attempts when an unavailability period is activated.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a UE. In certain configurations, the UE activates, by a processor of the UE, an unavailability period. The UE postpones, by the processor, a periodic Public Land Mobile Network (PLMN) search when the unavailability period is activated. The periodic PLMN search is controlled by a periodic attempt timer.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example procedure between a UE and a network.

FIG. 8 is a diagram illustrating an example of a UE postponing attempts to perform PLMN search during an unavailability period with the periodic attempt timer keep running.

FIG. 9 is a diagram illustrating an example of a UE postponing attempts to perform PLMN search during an unavailability period by interpreting a value of the periodic attempt timer in a way to extend the period between adjacent periodic PLMN searches.

FIG. 10 is a diagram illustrating an example of a UE postponing attempts to perform PLMN search during an unavailability period by utilizing a separate timer.

FIG. 11 is a flow chart of a method (process) of wireless communication of a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

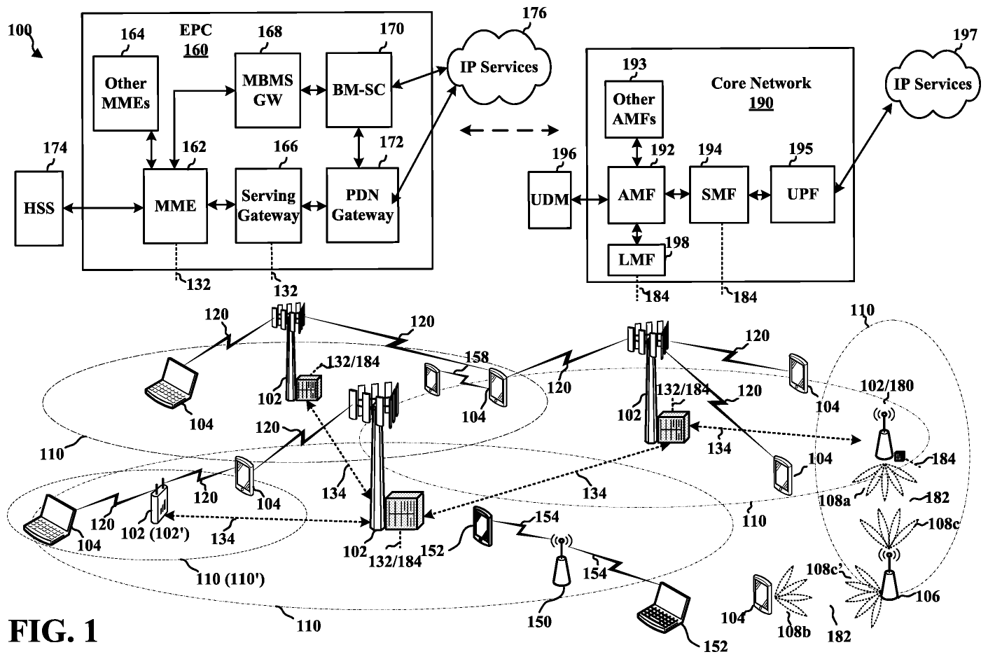

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

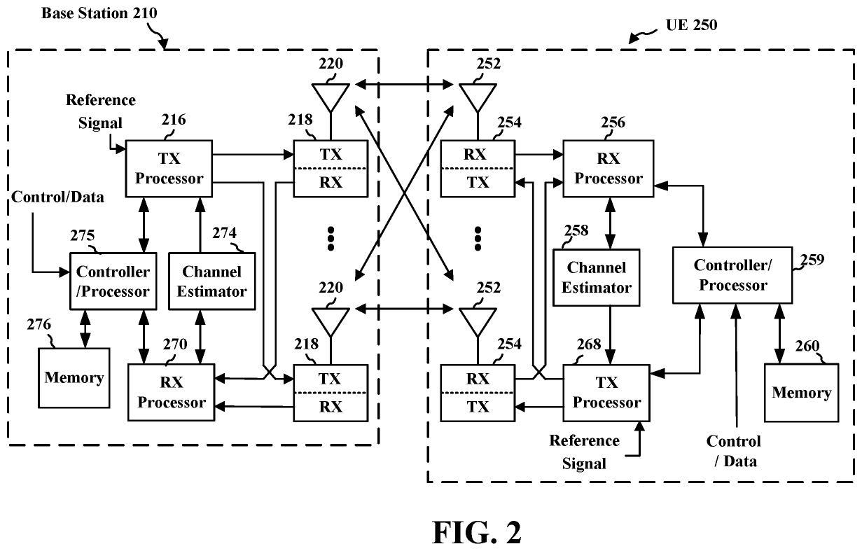

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

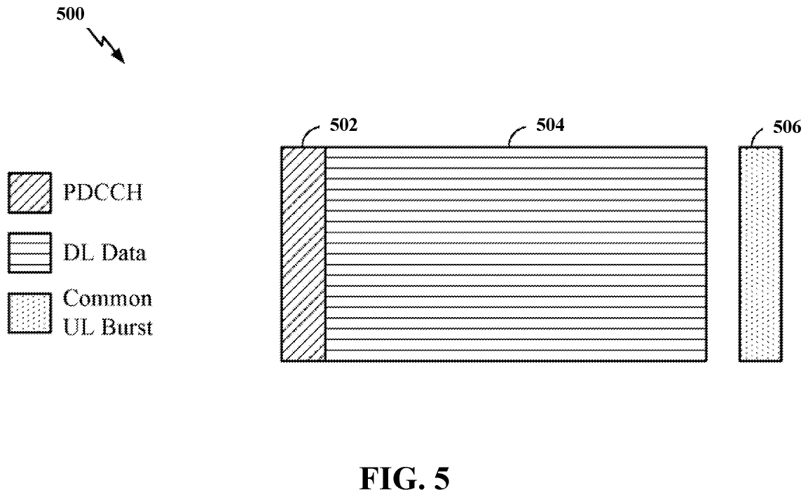

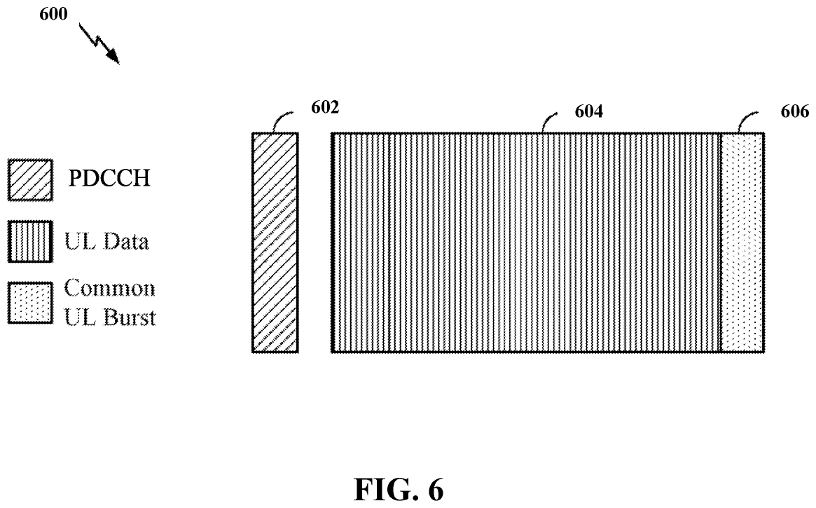

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

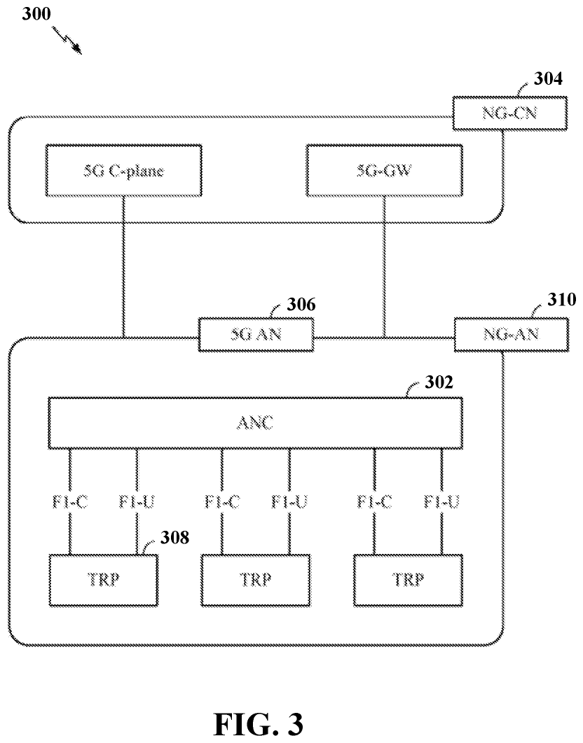

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

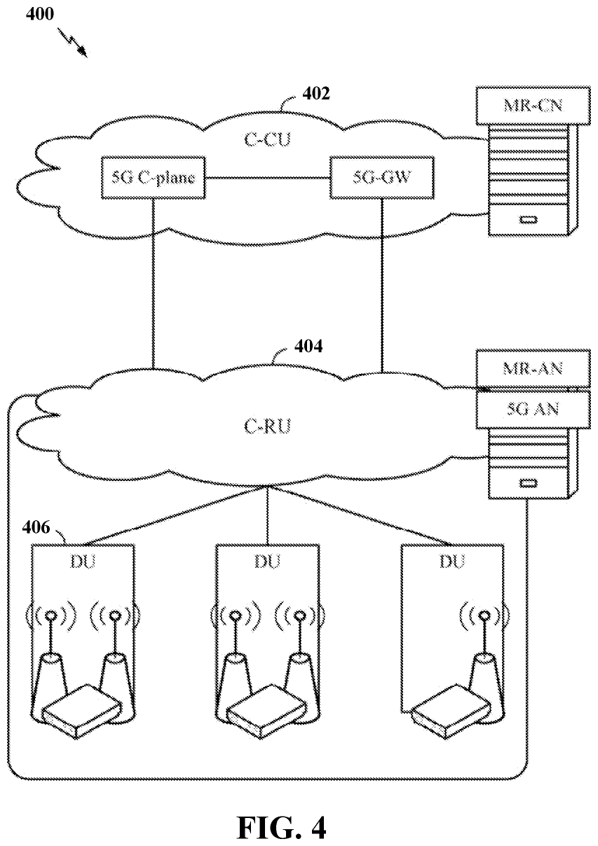

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

In certain configurations, if the UE and the network (e.g., AMF) support the unavailability period feature, and an event is triggered in the UE making the UE unavailable for a certain period of time, the UE shall activate the unavailability period and may store its 5GMM and 5GSM context in the UE (e.g., in a Universal Subscriber Identity Module (USIM) or a non-volatile memory in the UE) to be able to reuse it after the unavailability period. To activate the unavailability period, the UE provides an unavailability period duration to the AMF during the registration procedure or during the de-registration procedure, as described in 3GPP Technical Specification (TS) 23.501 and 23.502. The support for the unavailability period is negotiated in the registration procedure. When the unavailability period is activated, the UE does not stop a timer T (e.g., a periodic attempt timer) controlling the periodic PLMN search for a home PLMN (HPLMN), or an equivalent PLMN (EHPLMN) or other higher priority PLMNs.

However, if the UE is in a visited PLMN (VPLMN), regardless of whether the unavailability period is activated or not, the UE shall periodically search potential higher priority PLMNs. Thus, the periodic PLMN search is not optimized for the UE when unavailability period is activated. The periodic PLMN search procedure causes mode power consumption, which leads to drain device battery soon. Therefore, a need exists for improvements in the periodic PLMN search attempts when the unavailability period is activated.

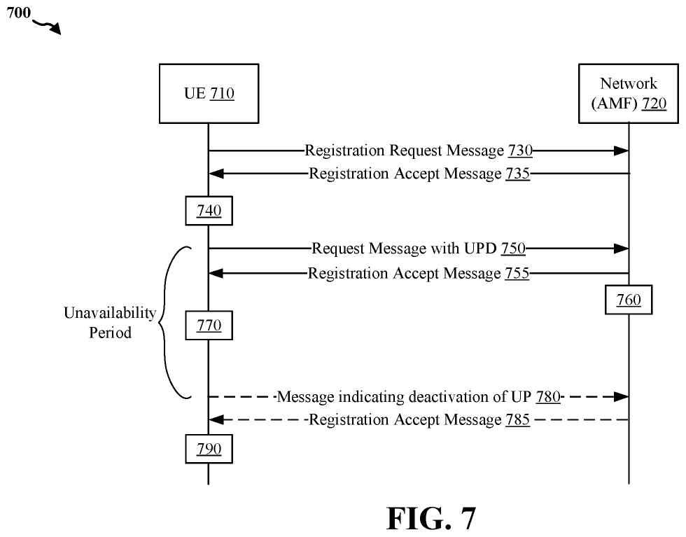

FIG. 7 is a diagram illustrating an example procedure between a UE and a network. Specifically, the UE 710 and the network 720 (e.g., AMF) may both support the unavailability period feature. As shown in FIG. 7, when the UE 710 is within the NR satellite access coverage of the network 720, the UE 710 sends a registration request 730 to the network 720 to become registered. Upon receiving the registration request from the UE 710, the network 720 sends a registration accept message 735 back to the UE 710 to confirm the receipt of the registration request 730. In this case, the UE 710 enters a registered mode. In certain configurations, the registration request 730 may include the unavailability period duration.

At operation 740, an event occurs to trigger the UE 710 to enter the unavailability period, such that the UE 710 may be deemed unavailable for a period of time. Upon being trigger by the event, the UE 710 sends a request message 750 to the network 720 to indicate information of the unavailability period. In certain configurations, the request message 750 may include information related to the unavailability period, such as the indication and type of unavailability, the start of the unavailability period (if known), and an unavailability period duration (UPD) (if known). Upon receiving the request message 750 from the UE 710, the network 720 sends a corresponding registration accept message 755 back to the UE 710 to confirm receipt of the request message 750. At operation 760, the network 720 stores the information related to the unavailability period in the UE context and determines that the UE 710 is not reachable during the UPD. In this case, the network 720 does not page the UE 710 during the UPD.

When the UE 710 enters the unavailability period, a periodic attempt timer (e.g., the timer T), which is used to trigger the UE for performing the PLMN search, may keep running. Specifically, the periodic attempt timer is set with a value indicating a pre-configured periodic attempt time, and is “periodic” such that when a current periodic attempt timer expires, the UE 710 may perform the PLMN search and restart a new periodic attempt timer with the value of the pre-configured periodic attempt time. In certain embodiments, the value of the periodic attempt timer may be preconfigured and stored in the UE 710 (e.g., in the USIM or the nonvolatile memory of the UE). Alternatively, in certain embodiments, if there is no preconfigured value, the UE may use a default value of 60 minutes for the periodic attempt timer. When the UE 710 enters the unavailability period and the periodic attempt timer is running, the UE 710 does not stop the periodic attempt timer. Examples of the PLMN search may include, without being limited to, performing periodic scan or attempting to access a HPLMN, or an EHPLMN or other higher priority PLMNs. Generally, when the UE 710 is not in the unavailability period, the expiration of the periodic attempt timer indicates a trigger to the UE 710 with an attempt to perform the PLMN search, e.g., performing periodic scan or attempting to access the HPLMN or the EHPLMN or other higher priority PLMNs. At operation 770, during the unavailability period, the UE 710 may postpone the PLMN search (i.e., the attempt to perform the PLMN search) since the unavailability period is activated. Specifically, the UE 710 may check the UE availability status (e.g., whether the UE 710 is flagged to be in the unavailability period, or whether an unavailability period timer is still running) when the periodic attempt timer expires, thus determining whether the expiration of the periodic attempt timer is during the unavailability period. When the periodic attempt timer expires during the unavailability period, the expiration of the periodic attempt timer does not trigger the UE 710 to perform the PLMN search. Thus, when the periodic attempt timer expires during the unavailability period, the UE 710 does not perform the PLMN search, e.g., not attempting to perform periodic scan or attempting to access the HPLMN or the EHPLMN or other higher priority PLMNs during the unavailability period. Instead, the UE 710 waits until the end of the unavailability period to perform the postponed attempt for the PLMN search.

In certain configurations, when the unavailability period ends, the UE 710 sends a message 780 to the network 720 to indicate the deactivation of the unavailability period. Upon receiving the message 780, the network 720 sends a registration accept message 785 back to the UE 710 to confirm receipt of the message 780. At operation 790, the UE 710 performs the postponed attempt for the PLMN search, e.g., attempting to perform periodic scan or attempting to access the HPLMN or the EHPLMN or other higher priority PLMN based on the postponed attempt(s). In certain configurations, there may be multiple attempts (i.e., multiple expirations of the periodic attempt timer) being postponed during the unavailability period, and the UE 710 may perform one PLMN search after the unavailability period regardless of the quantity of the postponed attempt(s) during the unavailability period.

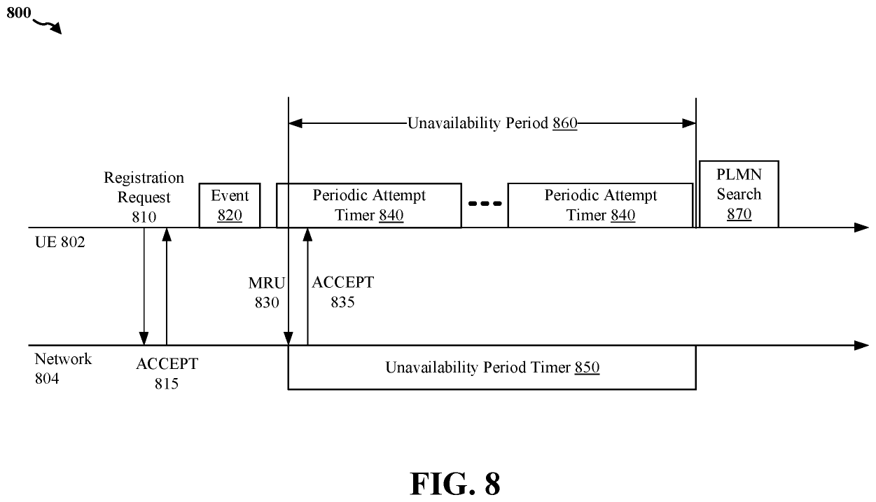

FIG. 8 is a diagram illustrating an example of a UE postponing attempts to perform PLMN search during an unavailability period with the periodic attempt timer keep running. Specifically, in the procedure 800, the UE 802 (i.e., the UE 710) allows the periodic attempt timer to keep running in the unavailability period.

As shown in FIG. 8, when the UE 802 is within the NR satellite access coverage of the network 804, the UE 802 sends a registration request 810 to the network 804 to become registered. Upon receiving the registration request from the UE 802, the network 804 sends a registration accept message (i.e., ACCEPT 815) back to the UE 802 to confirm the receipt of the registration request 810, allowing the UE 802 to enter a registered mode. When the UE 802 detects an event 820 that triggers the UE 802 to enter the unavailability period, the UE 802 sends a request message 830 (e.g., a mobility registration update (MRU) message) to the network 804 to indicate information of the unavailability period 860. Specifically, the MRU message 830 may include information related to the unavailability period, such as the indication and type of unavailability, the start of the unavailability period (if known), and the UPD (if known). At the network 804, upon receiving the MRU message 830, the network 804 sets an unavailability period timer 850 based on the start of the unavailability period and the UPD, and sends a registration accept message (i.e., ACCEPT 835) back to the UE 802.

As shown in FIG. 8, a periodic attempt timer 840 may run before the unavailability period 860 starts. When the unavailability period 860 is activated, the periodic attempt timer 840 may keep running on the UE 802. It is possible that the periodic attempt timer 840 may expire for one or more times during the unavailability period 860, based on the time period of the unavailability period 860 and the value of the periodic attempt timer 840. At the expiration of each periodic attempt timer 840, the UE 802 postpones the PLMN search (e.g., not performing the PLMN search) until the expiry of the unavailability period 860. When the unavailability period 860 ends, the UE 802 performs the postponed PLMN search 870. Although not shown in FIG. 8, the UE 802 may send a message to the network 804 to indicate the deactivation of the unavailability period 860 at the end of the unavailability period 860. In this case, the UE 802 performs the postponed PLMN search 870 when the unavailability period 860 is deactivated.

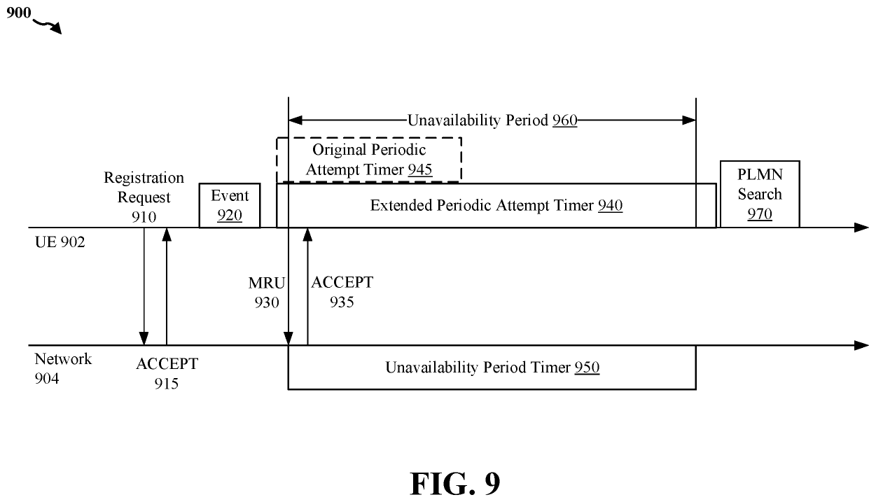

FIG. 9 is a diagram illustrating an example of a UE postponing attempts to perform PLMN search during an unavailability period by interpreting a value of the periodic attempt timer in a way to extend the period between adjacent periodic PLMN searches. Specifically, in the procedure 900, the UE 902 (i.e., the UE 710) allows the periodic attempt timer to keep running in the unavailability period. However, instead of running the periodic attempt timer in the regular way, the UE 902 interprets the value of the periodic attempt timer in a way to extend the period between two adjacent periodic PLMN searches when the unavailability period is activated, thus postponing the periodic PLMN search.

As shown in FIG. 9, when the UE 902 is within the NR satellite access coverage of the network 904, the UE 902 sends a registration request 910 to the network 904 to become registered. Upon receiving the registration request from the UE 902, the network 904 sends a registration accept message (i.e., ACCEPT 915) back to the UE 902 to confirm the receipt of the registration request 910, allowing the UE 902 to enter a registered mode. When the UE 902 detects an event 920 that triggers the UE 902 to enter the unavailability period, the UE 902 sends a request message 930 (e.g., the MRU message) to the network 904 to indicate information of the unavailability period 960. Specifically, the MRU message 930 may include information related to the unavailability period, such as the indication and type of unavailability, the start of the unavailability period (if known), and the UPD (if known). At the network 904, upon receiving the MRU message 930, the network 904 sets an unavailability period timer 950 based on the start of the unavailability period and the UPD, and sends a registration accept message (i.e., ACCEPT 935) back to the UE 902.

As shown in FIG. 9, a periodic attempt timer may run before the unavailability period 960 starts. When the unavailability period 960 is activated, the periodic attempt timer may keep running on the UE 902. However, instead of running the periodic attempt timer based on its value (i.e., the original periodic attempt timer 945), the UE 902 interprets the value of the periodic attempt timer by in a way to extend the period between two adjacent periodic PLMN searches. In certain configurations, the UE 902 may implement such interpretation by multiplying the value of the original periodic attempt timer 945 by a factor in the unavailability period 960, where the factor is in units of hours. For example, the UE 902 may adopt a 2-hour factor, and if the value of the original periodic attempt timer 945 is “4,” the interpretation would render an extended periodic attempt timer 940 to be 8 hours (=4×2 hours). The factor may be an operator/UE manufacturer factor which is preconfigured and stored in the UE 902 (e.g., in the USIM or nonvolatile memory of the UE), or may be a particular 3GPP standardized factor. In this case, compared to the original periodic attempt timer 945, which may expire during the unavailability period 960, the extended periodic attempt timer 940 may be extended by the factor to run beyond the end of the unavailability period 960, thus essentially postponing the periodic PLMN search. When the unavailability period 960 ends, the UE 902 performs the postponed PLMN search 970 when the extended periodic attempt timer 940 expires. Although not shown in FIG. 9, after the attempt of the PLMN search 970, since the UE 902 is no longer in the unavailability period 960, the UE 902 may restart another periodic attempt timer with the value of the periodic attempt timer (i.e., without the factor), and the UE 902 may continue performing the periodic PLMN searches with the regular value of the periodic attempt timer.

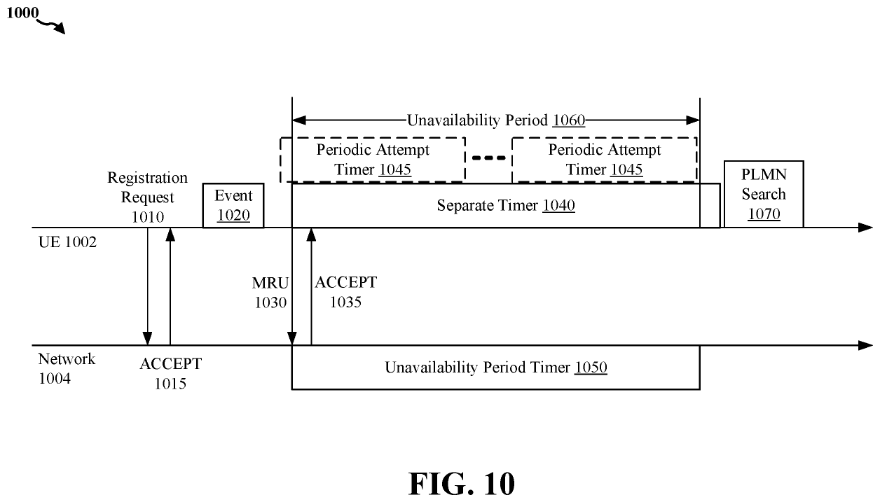

FIG. 10 is a diagram illustrating an example of a UE postponing attempts to perform PLMN search during an unavailability period by utilizing a separate timer. Specifically, in the procedure 1000, the UE 1002 (i.e., the UE 710) allows the periodic attempt timer to keep running in the unavailability period. However, instead of controlling the periodic PLMN search by the periodic attempt timer, the UE 1002 utilizes a separate timer different from the periodic attempt timer in the unavailability period. In this case, the periodic PLMN search is now controlled by the separate timer and not by the periodic attempt timer when the unavailability period is activated, thus postponing the periodic PLMN search.

As shown in FIG. 10, when the UE 1002 is within the NR satellite access coverage of the network 1004, the UE 1002 sends a registration request 1010 to the network 1004 to become registered. Upon receiving the registration request from the UE 1002, the network 1004 sends a registration accept message (i.e., ACCEPT 1015) back to the UE 1002 to confirm the receipt of the registration request 1010, allowing the UE 1002 to enter a registered mode. When the UE 1002 detects an event 1020 that triggers the UE 1002 to enter the unavailability period, the UE 1002 sends a request message 1030 (e.g., the MRU message) to the network 1004 to indicate information of the unavailability period 1060. Specifically, the MRU message 1030 may include information related to the unavailability period, such as the indication and type of unavailability, the start of the unavailability period (if known), and the UPD (if known). At the network 1004, upon receiving the MRU message 1030, the network 1004 sets an unavailability period timer 1050 based on the start of the unavailability period and the UPD, and sends a registration accept message (i.e., ACCEPT 1035) back to the UE 1002.

As shown in FIG. 10, a periodic attempt timer 1045 may run before the unavailability period 1060 starts. When the unavailability period 1060 is activated, the periodic attempt timer 1045 may keep running on the UE 1002. However, instead of regularly controlling the periodic PLMN search by the periodic attempt timer 1045, the UE 1002 utilizes a separate timer 1040 to control the periodic PLMN search. The separate timer 1040 is different from the periodic attempt timer 1045, and the value of the separate timer 1040 is greater than the value of the periodic attempt timer 1045. Thus, by configuring the periodic PLMN search to be controlled by the separate timer 1040 and not by the periodic attempt timer 1045 when the unavailability period 1060 is activated, the UE 1002 may configure the value of the separate timer 1040 to ensure the separate timer 1040 not to expire during the unavailability period 1060. It should be noted that the periodic attempt timer 1045 may expire for one or more times during the unavailability period 1060, based on the time period of the unavailability period 1060 and the value of the periodic attempt timer 1045. However, since the periodic PLMN search is now controlled by the separate timer 1040 and not by the periodic attempt timer 1045, no PLMN search will be performed during the unavailability period 1060, thus essentially postponing the periodic PLMN search. When the unavailability period 1060 ends, the UE 1002 performs the postponed PLMN search 1070 when the separate timer 1040 expires. Although not shown in FIG. 10, after the attempt of the PLMN search 1070, the UE 1002 may now switch back to the regular periodic PLMN search control scheme, and the PLMN search is again controlled by the periodic attempt timer 1045.

It should be noted that, in each of the procedures 800, 900 and 1000, the PLMN search is postponed with different solutions when the unavailability period is activated. However, the postponing of the PLMN search in the unavailability period may be implemented by other procedures, and is not limited thereto.

With the periodic attempts to perform the PLMN search being postponed during the unavailability period, the UE may avoid performing the PLMN search during the unavailability period while the UE may keep the periodic attempt timer running during the unavailability period.

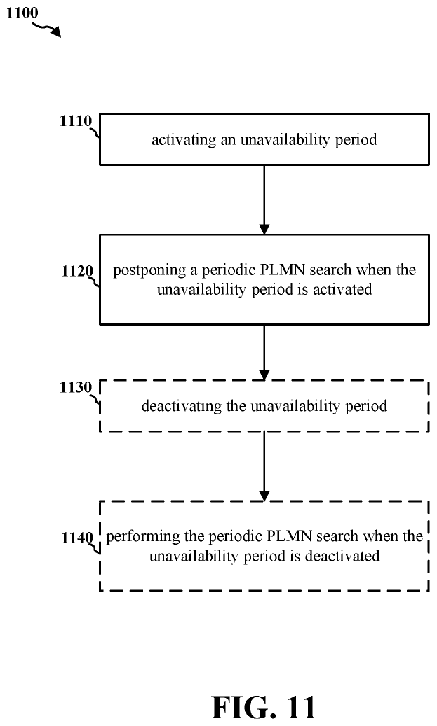

FIG. 11 is a flow chart of a method (process) of wireless communication of a UE. The method may be performed by a UE, e.g., the UE 710. At operation 1110, the UE activates, by a processor of the UE, an unavailability period. At operation 1120, the UE postpones, by the processor, a periodic PLMN search when the unavailability period is activated. The periodic PLMN search is controlled by a periodic attempt timer. Optionally, at operation 1130, the UE deactivates, by the processor, the unavailability period. Then, at operation 1140, the UE performs the periodic PLMN search when the unavailability period is deactivated.

In certain embodiments, a value of the periodic attempt timer is stored in the UE. In certain embodiments, the periodic attempt timer has a default value of 60 minutes.

In certain embodiments, the UE postpones the periodic PLMN search by allowing the periodic attempt timer to keep running in the unavailability period; and postponing the periodic PLMN search upon expiry of the periodic attempt timer when the unavailability period is activated.

In certain embodiments, the UE postpones the periodic PLMN search by interpreting a value of the periodic attempt timer in a way to extend a duration between two adjacent periodic PLMN searches when the unavailability period is activated. In one embodiment, the interpretation is implemented by multiplying the value of the periodic attempt timer by a factor in the unavailability period, wherein the factor is in units of hours. The factor may be preconfigured and stored in the UE.

In certain embodiments, the UE postpones the periodic PLMN search by utilizing a separate timer in the unavailability period. The separate timer is different from the periodic attempt timer, and the periodic PLMN search is controlled by the separate timer and not by the periodic attempt timer when the unavailability period is activated.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
activating, by a processor of the UE, an unavailability period; and
postponing, by the processor, a periodic Public Land Mobile Network (PLMN) search when the unavailability period is activated,
wherein the periodic PLMN search is controlled by a periodic attempt timer.

2. The method of claim 1, wherein a value of the periodic attempt timer is stored in the UE.

3. The method of claim 1, wherein the periodic attempt timer has a default value of 60 minutes.

4. The method of claim 1, further comprising:
deactivating, by the processor, the unavailability period; and
performing, by the processor, the periodic PLMN search when the unavailability period is deactivated.

5. The method of claim 1, wherein the postponing of the periodic PLMN search comprises:
allowing the periodic attempt timer to keep running in the unavailability period; and
postponing the periodic PLMN search upon expiry of the periodic attempt timer when the unavailability period is activated.

6. The method of claim 1, wherein the postponing of the periodic PLMN search comprises:
interpreting a value of the periodic attempt timer in a way to extend a duration between two adjacent periodic PLMN searches when the unavailability period is activated.

7. The method of claim 6, wherein the interpreting of the value of the periodic attempt timer comprises:
multiplying the value of the periodic attempt timer by a factor in the unavailability period, wherein the factor is in units of hours.

8. The method of claim 7, wherein the factor is preconfigured and stored in the UE.

9. The method of claim 1, wherein the postponing of the periodic PLMN search comprises:
utilizing a separate timer in the unavailability period,
wherein the separate timer is different from the periodic attempt timer, and the periodic PLMN search is controlled by the separate timer and not by the periodic attempt timer when the unavailability period is activated.

10. An apparatus for wireless communication, the apparatus being a user equipment (UE), comprising:
a memory; and
at least one processor coupled to the memory, the processor being configured to:
activate an unavailability period; and
postpone a periodic Public Land Mobile Network (PLMN) search when the unavailability period is activated,
wherein the periodic PLMN search is controlled by a periodic attempt timer.

11. The apparatus of claim 10, wherein a value of the periodic attempt timer is stored in the UE.

12. The apparatus of claim 10, wherein the periodic attempt timer has a default value of 60 minutes.

13. The apparatus of claim 10, wherein the processor is further configured to:
deactivate the unavailability period; and
perform the periodic PLMN search when the unavailability period is deactivated.

14. The apparatus of claim 10, wherein the processor is configured to postpone the periodic PLMN search by:
allowing the periodic attempt timer to keep running in the unavailability period; and
postponing the periodic PLMN search upon expiry of the periodic attempt timer when the unavailability period is activated.

15. The apparatus of claim 10, wherein the processor is configured to postpone the periodic PLMN search by:
interpreting a value of the periodic attempt timer in a way to extend a duration between two adjacent periodic PLMN searches when the unavailability period is activated.

16. The apparatus of claim 15, wherein the interpreting of the value of the periodic attempt timer comprises:
multiplying the value of the periodic attempt timer by a factor in the unavailability period, wherein the factor is in units of hours.

17. The apparatus of claim 16, wherein the factor is preconfigured and stored in the UE.

18. The apparatus of claim 10, wherein the processor is configured to postpone the periodic PLMN search by:
utilizing a separate timer in the unavailability period,
wherein the separate timer is different from the periodic attempt timer, and the periodic PLMN search is controlled by the separate timer and not by the periodic attempt timer when the unavailability period is activated.

19. A computer-readable medium storing computer executable code for performing wireless communication of a user equipment (UE), comprising code to:
activate, by a processor of the UE, an unavailability period; and
postpone, by the processor, a periodic Public Land Mobile Network (PLMN) search when the unavailability period is activated,
wherein the periodic PLMN search is controlled by a periodic attempt timer.

20. The computer-readable medium of claim 19, further comprising code to:
deactivate, by the processor, the unavailability period; and
perform, by the processor, the periodic PLMN search when the unavailability period is deactivated.
